(19) United States
(12) Patent Application Publication
(10) Pub. No.: US 2007/0014978 A1
(43) Pub. Date: Jan. 18, 2007

(54) Method of flame blocking and articles made therefrom

(76) Inventor: Anthony Poloso, Praireville, LA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/183,680

(22) Filed: Jul. 18, 2005

(51) Int. Cl. B32B 27/32; B32B 27/18

(52) U.S. Cl. 428/212; 428/516; 156/244.11; 264/173.14; 264/173.19

(57) ABSTRACT

This invention relates to a method of making a pallet assembly comprising: (a) extruding (1) a first layer comprising a flame retardant polyethylene composition comprising a polyethylene having a density ranging from about 0.920 g/cc to about 0.970 g/cc and from about 0.15 wt % to about 40 wt % of a flame retardant material, wherein the wt % is based on the total weight of the first layer; and (2) a second layer comprising a polyolefin polymer composition comprising a polyolefin polymer and less than about 40 wt % of the flame retardant material, wherein the wt % is based on the total weight of the second layer and wherein the wt % of the flame retardant in the second layer is less than the wt % of the flame retardant in the first layer and (b) processing the first layer and the second layer to form the pallet assembly.

### FIELD OF THE INVENTION

This invention relates to flame blocking and flame resistant articles, including but not limited to pallet assemblies. More particularly this invention relates to a method of flame blocking in articles made from polyolefin plastics and having non-uniform amounts of flame retardant in different portions of the article and the articles made therefrom.

### BACKGROUND OF THE INVENTION

Many articles, for example, shipping pallets, are made largely of wood. Polymers are increasingly being used to replace certain wooden articles to provide certain advantages. For example, shipping pallets may be injection molded into complex shapes to facilitate containment and shipping of various items. Also, polyolefinic plastic shipping pallets are easy to clean and resistant to insect infestation, thus increasing their useful life.

In order to compete with traditional wooden articles, the enhancement of flame resistance, durability and strength of polymer pallets or pallet assemblies is desirable.

U.S. Pat. No. 6,758,148 B2 discloses a method of fire retarding a pallet assembly comprising the steps of providing a pallet assembly comprising at least one pallet member having external surfaces; and affixing a flame retardant material to said at least one pallet member so as to substantially cover all of said external surfaces of said pallet member, wherein said flame retardant material includes a flame retardant fabric comprising a blend of polymeric fibers. The process requires providing a pallet and then affixing the flame retardant material to the pallet rather than coextruding the pallet and flame retardant material. An extra step is required in fabrication which adversely affects the cost of the finished pallet.

U.S. Pat. No. 6,849,677 B2 discloses a flame retardant molded polyolefin pallet comprising one or more subassemblies, at least one subassembly comprising a polyolefin containing a flame retardant package comprising as flame retardant components (a) 4-14% halogenated organic flame retardant, (b) 4-15% alumina trihydrate, and (c) 1-5% antimony trioxide, said percentages based on the weight of polyolefin and the sum of flame retardant components (a) to (c). The flame retardant package is dispersed uniformly throughout the article or subassembly prepared by this method rather than having non-uniform distribution of the flame retardant material. The uniform distribution of the flame retardant material adversely affects the physical properties, such as impact strength, of the article.

There exists a need for polymer articles, for example, plastic pallets or pallet assemblies, to have flame resistant characteristics. Preferably the presence of flame retardant materials would have little or no detrimental effect on structural properties and minimize the incremental cost of the polymer articles.

Additional references of interest include: U.S. Pat. Nos. 6,174,942 B1; 6,448,307 B1; 6,579,926 B1; 6,745,703 B2; 6,784,234 B2; U.S. Publication 2004/0171731 A1; PCT Publication WO 02/18485 A1; EP 1 458 617 B1; JP10-338308A and JP11-278485A1.

### SUMMARY OF THE INVENTION

This invention relates to an article or pallet assembly comprising: (a) a first layer comprising a polyethylene having a density ranging from about 0.920 g/cc to about 0.970 g/cc and up to about 40 wt % of a flame retardant material, wherein the wt % is based on the total weight of the first layer and (b) a second layer comprising a polyolefin polymer and less than about 40 wt % of a flame retardant material, wherein the wt % is based on the total weight of the second layer, and wherein the wt % of the flame retardant in the second layer is less than the wt % of the flame retardant in the first layer.

This invention relates to a method of making an article or pallet assembly comprising (a) extruding (1) a first layer comprising a flame retardant polyethylene composition comprising a polyethylene having a density ranging from about 0.920 g/cc to about 0.970 g/cc and up to about 40 wt % of a flame retardant material, wherein the wt % is based on the total weight of the first layer; and (2) a second layer comprising a polyolefin polymer composition comprising a polyolefin polymer and less than about 40 wt % of the flame retardant material, wherein the wt % is based on the total weight of the second layer, and (b) processing the first layer and the second layer to form the article or pallet assembly.

### BRIEF DESCRIPTION OF THE DRAWINGS

A more complete appreciation of the invention will be readily obtained by reference to the following detailed description when considered in connection with the accompanying drawings, wherein:

FIG. 1 is a cross section of a two layer pallet assembly having flame retardant material in one layer.

FIG. 2 is a cross section of a three layer pallet assembly having flame retardant material in the two external layers.

### DETAILED DESCRIPTION OF THE INVENTION

This invention relates to a method of making flame resistant articles, including but not limited to pallet assemblies, having non-uniform amounts of flame retardant materials throughout the article and the articles made therefrom. The articles have non-uniform amounts of flame retardant so that the higher concentrations of flame retardant materials may be located where those higher concentrations are more likely needed. The areas of lower concentration of flame retardant materials generally allow the overall structure to be more robust because the properties, such as stiffness, are not as effected as they would be by the presence of high levels of flame retardant materials.

Articles

One embodiment of this invention relates to an article or pallet assemble comprising: (a) a first layer comprising a polyethylene having a density ranging from about 0.920 g/cc to about 0.970 g/cc and up to about 40 wt % of a flame retardant material, wherein the wt % is based on the total weight of the first layer and (b) a second layer comprising a polyolefin polymer and less than about 40 wt % of a flame retardant material, wherein the wt % is based on the total weight of the second layer, and wherein the wt % of the flame retardant in the second layer is less than the wt % of the flame retardant in the first layer. In another embodiment the invention relates to an article or pallet assembly wherein the first layer and the second layer are co-extruded.

In another embodiment this invention relates to an article or pallet assembly further comprising a third layer comprising a polyethylene having a density ranging from about 0.920 g/cc to about 0.970 g/cc and up to about 40 wt % of a flame retardant material, wherein the wt % is based on the total weight of the third layer, and wherein (a) the second layer is between the first layer and the third layer and (b) the polyethylene in the third layer may be the same as or different from the polyethylene in the first layer.

In yet another embodiment the invention relates to an article or pallet assembly further comprising one or more additional layers between the first layer and the second layer, wherein the additional layers each comprise less than about 1 wt % flame retardant material based on the total weight of each respective layer. In another embodiment the invention relates to an article or pallet assembly further comprising one or more additional layers between the second layer and the third layer, wherein the additional layers each comprise less than about 1 wt % flame retardant material based on the total weight of each respective layer.

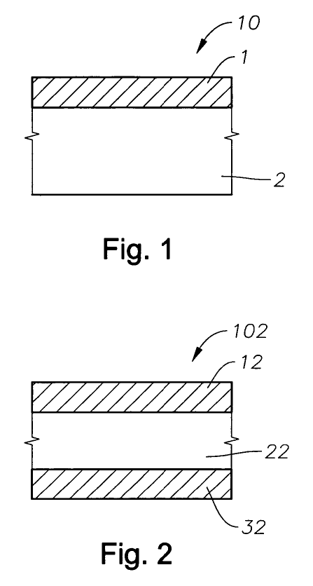

A cross-section of one embodiment of a multi-layer article 10, as shown in FIG. 1, has a first layer 1 and a second layer 2. Typically, the first and second layers have a relative thickness ratio ranging from about 1:1 to about 1:10, alternatively ranging from about 1:4 to about 1:10, alternatively ranging from about 1:6 to about 1:10, or alternatively ranging from about 1:8 to about 1:10.

FIG. 1 shows a cross section of an article 10, for example, a pallet assembly having a polyethylene layer 1 containing a flame retardant material and a polyolefin layer 2 having less flame retardant material than layer 1. The polyethylene layer 1 containing the flame retardant material is the layer that may be exposed to a heat source. The polyolefin layer 2, having less flame retardant material, or possibly no flame retardant material, retains impact properties similar to the unmodified polyolefin. Separating the article, such as a pallet assembly, into two or more layers, one having the flame retardant material and one having a reduced amount of flame retardant material, will improve the impact properties of the article relative to an article with flame retardant material distributed throughout the article.

A cross-section of one embodiment of a multi-layer article 102 of the present invention is depicted in FIG. 2, which shows a first layer 12, a second layer 22 and an third layer 32 that have a relative thickness ratio ranging from about 1:1:1 to about 1:10:1, respectively. Alternatively, the thickness ratio of the first, second, and third layer of the present invention is from about 1:2:1 to about 1:10:1, or from about 1:4:1 to about 1:10:1, or from about 1:6:1 to about 1:10:1.

FIG. 2 shows a cross section of an article 102, such as a pallet assembly, having a polyethylene layer 12 containing a flame retardant material, a polyolefin layer 22 having less flame retardant material than at least one of layer 1 or layer 2, and a polyethylene layer 32 containing a flame retardant material. The polyethylene layers 12 or 32 containing the flame retardant material are the layers that may be exposed to a heat source. The polyolefin layer 22, having less flame retardant material, or possibly no flame retardant material, retains impact properties similar to the unmodified polyolefin. Separating the article into two or more layers, one having the flame retardant material and one having a reduced amount of flame retardant material, will improve the impact properties of the article relative to an article with flame retardant material distributed throughout the article.

In another embodiment the invention relates to an article, for example, a pallet assembly, wherein the density of the polyethylene in the first layer ranges from about 0.920 g/cc to about 0.970 g/cc, or from about 0.930 g/cc to about 0.970 g/cc, or from about 0.940 g/cc to about 0.970 g/cc, or from about 0.950 g/cc to about 0.960 g/cc.

In another embodiment the invention relates to an article, such as a pallet assembly, wherein the first layer comprises up to about 30 wt % flame retardant material, or up to about 20 wt % flame retardant material, or up to about 15 wt % flame retardant material, or up to about 10 wt % flame retardant material.

In one embodiment this invention relates to an article, for example, a pallet assembly, wherein the first layer has a thickness of at least about 0.1 mm, or at least about 0.3 mm, or at least about 0.5 mm.

In one embodiment of this invention the second layer comprises a polyolefin polymer and less than about 40 wt % of a flame retardant material, wherein the wt % of the flame retardant material is based on the total weight of the second layer, and wherein the wt % of the flame retardant in the second layer is less than the wt % of the flame retardant in the first layer. Another embodiment of this invention relates to an article, such as a pallet assembly, wherein the second layer comprises less about 30 wt % flame retardant material, or less than about 20 wt % flame retardant material, or less than about 10 wt % flame retardant material, or less than about 1 wt % flame retardant material. In another embodiment this invention relates to an article, for example, a pallet assembly, wherein the second layer comprises at least about 0.1 wt % of the flame retardant material. In all of these embodiments the wt % of flame retardant material in the second layer is less than the wt % of the flame retardant material in the first layer.

In one embodiment of this invention the polyolefin polymer comprises a homopolymer or copolymer of at least one of polyethylene, polyethylene blended with an impact modifier, polyethylene regrind, or polypropylene. The impact modifiers include, but are not limited to, polyethylene plastomers having densities less than 0.90 g/cc and thermoplastic rubbers.

In one embodiment of this invention the polyolefin polymer in the second layer comprises a polyethylene wherein the density ranges from about 0.920 g/cc to about 0.970 g/cc, or from about 0.930 g/cc to about 0.970 g/cc, or from about 0.940 g/cc to about 0.970 g/cc, or from about 0.950 g/cc to about 0.960 g/cc.

In one embodiment of this invention the flame retardant material comprises at least one of a halogenated organic compound, antimony trioxide, alumina trihydrate or a nitrogenous organic compound. In one embodiment of this invention the halogenated organic compound comprises at least one of polybrominated biphenyl oxides, decabromodiphenyl oxide, halogenated phosphate esters, or tetrabromobisphenol A. In another embodiment of this invention the nitrogenous organic compound comprises at least one of urea, melamine, or formaldehyde condensates thereof.

In one embodiment of this invention the article, such as a pallet assembly, comprises a pallet, a dunnage tray, a tote bin, a drum, a bottle, or a building panel. In another embodiment of this invention the article comprises a single component. In another embodiment of this invention the article comprises at least two components or subassemblies wherein at least one component or subassembly has a composition according to this invention as described above.

In one embodiment of this invention the article, for example, a pallet assembly, having a non-uniform distribution of flame retardant material (i.e., the first layer has a higher wt % of flame retardant material than the wt % of flame retardant material in the second layer) has improved impact resistance characteristics relative to a similar article having a uniform distribution of flame retardant material (i.e., the first and second layers, or the entire article if the article has no separate layers, have equal wt % of flame retardant materials).

Methods of Making Articles

One embodiment of this invention relates to a method of making an article, such as a pallet assembly, comprising: (a) extruding (1) a first layer comprising a flame retardant polyethylene composition comprising a polyethylene having a density ranging from about 0.920 g/cc to about 0.970 g/cc and up to about 40 wt % of a flame retardant material, wherein the wt % is based on the total weight of the first layer; and (2) a second layer comprising a polyolefin polymer composition comprising a polyolefin polymer and less than about 40 wt % of the flame retardant material, wherein the wt % is based on the total weight of the second layer and wherein the wt % of the flame retardant in the second layer is less than the wt % of the flame retardant in the first layer, and (b) processing the first layer and the second layer to form the article.

In another embodiment according to the present invention the method further comprises extruding a third layer comprising a polyethylene having a density ranging from about 0.920 g/cc to about 0.970 g/cc and up to about 40 wt % of a flame retardant material, wherein the wt % is based on the total weight of the third layer, and wherein (a) the second layer is between the first layer and the third layer and (b) the polyethylene in the third layer may be the same as or different from the polyethylene in the first layer.

In another embodiment according to the present invention the method further comprises extruding one or more additional layers between the first layer and the second layer, wherein the additional layers each comprise less than about 1 wt % flame retardant material based on the total weight of each respective layer. In another embodiment according to the present invention the method further comprises extruding one or more additional layers between the second layer and the third layer, wherein the additional layers each comprise less than about 1 wt % flame retardant material based on the total weight of each respective layer.

Another embodiment relates to the method of making an article, for example, a pallet assembly, further comprising blending the polyethylene having a density ranging from about 0.920 g/cc to about 0.970 g/cc and up to about 40 wt % of the flame retardant material to form the flame retardant polyethylene composition, wherein the wt % is based on the total weight of the polyethylene composition. In alternative embodiments the flame retardant polyethylene composition comprises up to about 30 wt % of the flame retardant material, or up to about 20 wt % of the flame retardant material, up to about 15 wt % of the flame retardant material or up to about 10 wt % of the flame retardant material.

One embodiment of this invention relates to a method of making an article, including but not limited to a pallet, wherein the density of the polyethylene in the first layer ranges from about 0.930 g/cc to about 0.970 g/cc, or from about 0.940 g/cc to about 0.970 g/cc, or from about 0.950 g/cc to about 0.960 g/cc.

Another embodiment relates to the method of making an article, including but not limited to a pallet, further comprising blending the polyolefin polymer and less than about 40 wt % of the flame retardant material to form the polyolefin polymer composition, wherein the wt % is based on the total weight of the polyolefin polymer composition. In alternative embodiments the method of making an article relates to the polyolefin polymer composition comprising less than about 30 wt % of the flame retardant material, or less than about 20 wt % of the flame retardant material, less than about 10 wt % of the flame retardant material, or less than about 1 wt % of the flame retardant material. In another embodiment, the method relates to the polyolefin polymer composition comprising at least about 0.1 wt % of the flame retardant material. In one embodiment of the method of making an article, such as a pallet assembly, the second layer of the article comprises an amount of flame retardant material corresponding to the amount of flame retardant material in the polyolefin polymer composition used to form the second layer of the article.

One embodiment of this invention relates to a method of making an article, for example a pallet assembly, wherein the polyolefin polymer comprises a homopolymer or copolymer of at least one of polyethylene, polyethylene blended with an impact modifier, polyethylene regrind, or polypropylene. Another embodiment of this invention relates to a method of making an article, such as a pallet assembly, wherein the polyolefin polymer comprises polyethylene having a density ranging from about 0.920 g/cc to about 0.970 g/cc, or from about 0.930 g/cc to about 0.970 g/cc, or from about 0.940 g/cc to about 0.970 g/cc, or from about 0.950 g/cc to about 0.960 g/cc.

One embodiment of this invention relates to a method of making an article, including but not limited to a pallet assembly, wherein the flame retardant material comprises at least one of a halogenated organic compound, antimony trioxide, alumina trihydrate, or a nitrogenous organic compound. Another embodiment of this invention relates to a method of making an article wherein the halogenated organic compound comprises at least one of polybrominated biphenyl oxides, halogenated phosphate esters, and/or tetrabromobisphenol A. Another embodiment of this invention relates to a method of making an article wherein the nitrogenous organic compound comprises at least one of urea, melamine, or formaldehyde condensates thereof.

One embodiment of this invention relates to a method of making a pallet assembly wherein the pallet assembly comprises a pallet, a dunnage tray, a tote bin, a drum, a bottle, or a building panel.

In one embodiment according to the present invention the method relates to processing in which the first layer and the second layer are co-extruded. In another embodiment the processing of the first layer and the second layer comprises at least one of single sheet thermoforming, twin sheet thermoforming, co-injection molding, roto-molding, blow molding, injection molding, compression molding, or profile extrusion. Processing of articles formed with more than two layers may also involve the co-extrusion processes listed above. Co-extrusion may be used for as few as two layers up to all the layers used to form an article. The molding processes are well known to those of ordinary skill in the art.

Processing Techniques

Thermoforming is a process of forming at least one pliable plastic sheet into a desired shape. An exemplary embodiment of a thermoforming sequence is described. However this should not be construed as limiting the thermoforming methods useful with the compositions of this invention. First, an extrudate sheet of the composition of this invention (and any other layers or materials) is placed on a shuttle rack to hold it during heating. The shuttle rack indexes into the oven that pre-heats the sheet before forming. Once the sheet is heated, the shuttle rack indexes back to the forming tool. The sheet is then vacuumed onto the forming tool to form the article and hold it in place. The forming tool can be either a “male” or “female” type tool. After cooling, the shaped article is then removed from the tool.

Thermoforming is accomplished by vacuum, positive air pressure, plug-assisted vacuum forming, or combinations and variations of these, once the sheet of material reaches thermoforming temperatures, typically of from about 140° C. to about 185° C. or higher. A pre-stretched bubble step is used, especially on large parts, to improve material distribution. In one embodiment, an articulating rack lifts the heated sheet towards a male forming tool, assisted by the application of a vacuum from orifices in the male forming tool. Once the sheet is firmly formed about the male forming tool, the thermoformed shaped article is then cooled, typically by blowers. Plug-assisted forming is generally used for small, deep drawn parts. Plug material, design, and timing can be critical to optimization of the process. Plugs made from insulating foam avoid premature quenching of the plastic. The plug shape is usually similar to the mold cavity, but smaller and without part detail. A round plug bottom will usually promote even material distribution and uniform sidewall thickness. For a semicrystalline polymer such as polypropylene, fast plug speeds generally provide the best material distribution in the part.

The shaped sheet is then cooled in the mold. Sufficient cooling to maintain a mold temperature of about 30° C. to about 85° C. is desirable. The part typically is below about 90° C. to about 100° C. before ejection in one embodiment. For good results in thermoforming, the highest melt strength polymers are desirable. Excess sheet material is then trimmed from the shaped article.

Twin sheet thermoforming is used to produce hollow parts. It uses the same principles as thermoforming described above but two sheets are thermoformed as two halves of a finished article and then brought together while still hot enough to fuse along the seam to form a single hollow part.

Blow molding is another suitable forming method, which includes, multi-layer blow molding, extrusion blow molding, and stretch blow molding, and is especially suitable for substantially closed or hollow objects, such as, for example, gas tanks and other fluid containers. Blow molding is described in more detail in, for example, CONCISE ENCYCLOPEDIA OF POLYMER SCIENCE AND ENGINEERING, pp. 90-92, (Jacqueline I. Kroschwitz, ed., John Wiley & Sons, 1990).

In yet another embodiment of the formation and shaping process, profile co-extrusion can be used. The profile co-extrusion process parameters are as above for the blow molding process, except the die temperatures (dual zone top and bottom) range from about 150° C. to about 235° C., the feed blocks are from about 90° C. to about 250° C., and the water cooling tank temperatures are from about 10° C. to about 60° C.

In an embodiment of the thermoforming process, the oven temperature is between about 160° C. and about 500° C., the time in the oven between about 50 and about 400 seconds, and the mold temperature, typically a female die, between about 25° C. and about 80° C. The final thickness of the cooled (room temperature), shaped sheet is from about 100 μm to about 10,000 μm in one embodiment, from about 200 μm to about 6,000 μm in another embodiment, and from about 250 μm to about 3,000 μm in yet another embodiment, and from about 500 μm to about 1,550 μm in yet another embodiment, a desirable range being any combination of any upper thickness limit with any lower thickness limit.

In yet another embodiment of the invention, the articles, including but not limited to pallet assemblies, of this invention may be produced using a co-extrusion blow molding operation. Blow molding is particularly useful in such applications as for making closed articles such as fuel tanks and other fluid containers, playground equipment, outdoor furniture, and small enclosed structures. In one embodiment of this process, articles of this invention are co-extruded through a multi-layer head to form a parison. The mold, with either male or female patterns inside, is then closed around the parison and air is blown into the mold to form the articles, for example, pallet, dunnage trays, tote bins, drums, bottles, and building panels.

It is understood by those skilled in the art that the steps outlined above may be varied, depending upon the desired result. For example, the extruded sheet of the articles of this invention may be directly thermoformed or blow molded without cooling, thus skipping a cooling step. Other parameters may be varied as well in order to achieve a finished article having desirable features.

Articles made using the methods of this invention are exemplified by, but not limited to, pallets, dunnage trays, tote bins, drums, bottles, and building panels. Pallets may be molded in several subassemblies and assembled using, for example, snap fittings, fusion or adhesive bonding, or other conventional assembly methods. The use of subassemblies permits the production of pallets having more complex shapes. One embodiment of this invention relates to pallets comprising a plurality of subassemblies comprising at least one subassembly made by the methods of this invention described above. Another embodiment of this invention relates to pallets comprising a plurality of subassemblies further comprising at least two subassemblies wherein at least two of the subassemblies have different flame retardant materials. One embodiment of this invention relates to an article formed as a multi-layer single component article that does not require further assembly.

One embodiment of this invention relates to a pallet comprising: a top deck, a bottom deck and a plurality of support columns connecting the top deck and the bottom deck. In one embodiment of this invention at least one of the top deck, the bottom deck or the plurality of support column comprises an article comprising: (a) a first layer comprising a polyethylene having a density ranging from about 0.920 g/cc to about 0.970 g/cc and up to about 40 wt % of a flame retardant material, wherein the wt % is based on the total weight of the first layer; and (b) a second layer comprising a polyolefin polymer and less than about 40 wt % of a flame retardant material, wherein the wt % is based on the total weight of the second layer, and wherein the wt % of the flame retardant in the second layer is less than the wt % of the flame retardant in the first layer. In another embodiment of this invention the top deck, the bottom deck and the plurality of columns each comprise an article as described above. In one embodiment of the invention the pallet or at least one subassembly is prepared by the method comprising: (a) extruding (1) a first layer comprising a flame retardant polyethylene composition comprising a polyethylene having a density ranging from about 0.920 g/cc to about 0.970 g/cc and up to about 40 wt % of a flame retardant material, wherein the wt % is based on the total weight of the first layer; and (2) a second layer comprising a polyolefin polymer composition comprising a polyolefin polymer and less than about 40 wt % of the flame retardant material, wherein the wt % is based on the total weight of the second layer and (b) processing the first layer and the second layer to form the pallet or subassembly.

One embodiment of this method provides a pallet having improved impact resistance relative to a pallet of similar polymer composition but having a uniform wt % of the flame retardant throughout the pallet and having a wt % of flame retardant equal to the wt % of flame retardant in the first layer of a pallet made according to the present invention. The improved impact resistance of a pallet made by the process of this invention is at least about 5%, or at least about 10%, or at least about 15% greater than a corresponding pallet having a similar wt % of flame retardant material uniformly distributed throughout the pallet.

Tests and Materials

Density was determined according to ASTM D-1505.

All documents described herein are incorporated by reference herein, including any priority documents and/or testing procedures. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A pallet assembly comprising:
(a) a first layer comprising a polyethylene having a density ranging from about 0.920 g/cc to about 0.970 g/cc and from about 0.15 wt % to about 40 wt % of a flame retardant material, wherein the wt % is based on the total weight of the first layer; and
(b) a second layer comprising a polyolefin polymer and less than about 40 wt % of a flame retardant material, wherein the wt % is based on the total weight of the second layer, and
wherein the wt % of the flame retardant in the second layer is less than the wt % of the flame retardant in the first layer.

2. The pallet assembly according to claim 1, wherein the second layer comprises at least about 0.1 wt % of the flame retardant material.

3. The pallet assembly according to claim 1, wherein the first layer and the second layer are co-extruded.

4. The pallet assembly according to claim 1, further comprising a third layer comprising a polyethylene having a density ranging from about 0.920 g/cc to about 0.970 g/cc and up to about 40 wt % of a flame retardant material, wherein (a) the wt % is based on the total weight of the third layer, (b) the second layer is between the first layer and the third layer, and (c) the polyethylene in the third layer may be the same as or different from the polyethylene in the first layer.

5. The pallet assembly according to claim 1, further comprising one or more additional layers between the first layer and the second layer, wherein the additional layers each comprise less than about 1 wt % flame retardant material based on the total weight of each respective layer.

6. The pallet assembly according to claim 4, further comprising one or more additional layers between the second layer and the third layer, wherein the additional layers each comprise less than about 1 wt % flame retardant material based on the total weight of each respective layer.

7. The pallet assembly according to claim 1, wherein the first layer comprises up to about 30 wt % of the flame retardant material.

8. The pallet assembly according to claim 7, wherein the first layer comprises up to about 20 wt % of the flame retardant material.

9. The pallet assembly according to claim 8, wherein the first layer comprises up to about 15 wt % of the flame retardant material.

10. The pallet assembly according to claim 9, wherein the first layer comprises up to about 10 wt % of the flame retardant material.

11. The pallet assembly according to claim 1, wherein the density of the polyethylene ranges from about 0.930 g/cc to about 0.970 g/cc.

12. The pallet assembly according to claim 11, wherein the density of the polyethylene ranges from about 0.940 g/cc to about 0.970 g/cc.

13. The pallet assembly according to claim 12, wherein the density of the polyethylene ranges from about 0.950 g/cc to about 0.960 g/cc.

14. The pallet assembly according to claim 1, wherein the polyolefin polymer comprises a homopolymer or copolymer of at least one of polyethylene, polyethylene blended with an impact modifier, polyethylene regrind or polypropylene.

15. The pallet assembly according to claim 1, wherein the polyolefin polymer comprises the polyethylene, wherein the density ranges from about 0.920 g/cc to about 0.970 g/cc.

16. The pallet assembly according to claim 15, wherein the density of the polyethylene ranges from about 0.930 g/cc to about 0.970 g/cc.

17. The pallet assembly according to claim 16, wherein the density of the polyethylene ranges from about 0.940 g/cc to about 0.970 g/cc.

18. The pallet assembly according to claim 17, wherein the density of the polyethylene ranges from about 0.950 g/cc to about 0.960 g/cc.

19. The pallet assembly according to claim 1, wherein the second layer comprises less than about 30 wt % of the flame retardant material.

20. The pallet assembly according to claim 19, wherein the second layer comprises less than about 20 wt % of the flame retardant material.

21. The pallet assembly according to claim 20, wherein the second layer comprises less than about 10 wt % of the flame retardant material.

22. The pallet assembly according to claim 21, wherein the second layer comprises less than about 1 wt % of the flame retardant material.

23. The pallet assembly according to claim 1, wherein the flame retardant material comprises at least one of a halogenated organic compound, antimony trioxide, alumina trihydrate, or a nitrogenous organic compound.

24. The pallet assembly according to claim 23, wherein the halogenated organic compound comprises at least one of polybrominated biphenyl oxides, decabromodiphenyl oxide, halogenated phosphate esters, tetrabromobisphenol A, or mixtures thereof.

25. The pallet assembly according to claim 23, wherein the nitrogenous organic compound comprises at least one of urea, melamine, or formaldehyde condensates thereof.

26. The pallet assembly according to claim 1, wherein the pallet assembly comprises a pallet, a dunnage tray, a tote bin, a drum, a bottle, or a building panel.

27. A method of making a pallet assembly comprising:
(a) extruding
(1) a first layer comprising a flame retardant polyethylene composition comprising:
a polyethylene having a density ranging from about 0.920 g/cc to about 0.970 g/cc and from about 0.15 wt % to about 40 wt % of a flame retardant material, wherein the wt % is based on the total weight of the first layer; and
(2) a second layer comprising a polyolefin polymer composition comprising:
a polyolefin polymer and less than about 40 wt % of the flame retardant material, wherein the wt % is based on the total weight of the second layer, and
(b) processing the first layer and the second layer to form the pallet assembly.

28. The method according to claim 27, wherein the first layer and the second layer are co-extruded.

29. The method according to claim 27, further comprising:
blending the polyethylene having a density ranging from about 0.920 g/cc to about 0.970 g/cc and up to about 40 wt % of the flame retardant material to form the flame retardant polyethylene composition, wherein the wt % is based on the total weight of the polyethylene composition.

30. The method according to claim 27, further comprising:
blending the polyolefin polymer and less than about 40 wt % of the flame retardant material to form the polyolefin polymer composition, wherein the wt % is based on the total weight of the polyolefin polymer composition.

31. The method according to claim 27, wherein the processing of the first layer and the second layer comprises at least one of single sheet thermoforming, twin sheet thermoforming, co-injection molding, roto-molding or blow molding.

32. The method according to claim 27, further comprising extruding a third layer comprising a polyethylene having a density ranging from about 0.920 g/cc to about 0.970 g/cc and up to about 40 wt % of a flame retardant material, wherein (a) the wt % is based on the total weight of the third layer, (b) the second layer is between the first layer and the third layer, and (c) the polyethylene in the third layer may be the same as or different from the polyethylene in the first layer.

33. The method according to claim 32, further comprising extruding one or more additional layers between the first layer and the second layer, wherein the additional layers each comprise less than about 1 wt % flame retardant material based on the total weight of each respective layer.

34. The method according to claim 33, further comprising extruding one or more additional layers between the second layer and the third layer, wherein the additional layers each comprise less than about 1 wt % flame retardant material based on the total weight of each respective layer.

35. The method according to claim 27, wherein the flame retardant polyethylene composition comprises up to about 30 wt % of the flame retardant material.

36. The method according to claim 35, wherein the flame retardant polyethylene composition comprises up to about 20 wt % of the flame retardant material.

37. The method according to claim 36, wherein the flame retardant polyethylene composition comprises up to about 10 wt % of the flame retardant material.

38. The method according to claim 37, wherein the flame retardant polyethylene composition comprises up to about 1 wt % of the flame retardant material.

39. The method according to claim 27, wherein the density of the polyethylene ranges from about 0.930 g/cc to about 0.970 g/cc.

40. The method according to claim 39, wherein the density of the polyethylene ranges from about 0.940 g/cc to about 0.970 g/cc.

41. The method according to claim 40, wherein the density of the polyethylene ranges from about 0.950 g/cc to about 0.960 g/cc.

42. The method according to claim 27, wherein the polyolefin polymer comprises a homopolymer or copolymer of at least one of polyethylene, polyethylene blended with an impact modifier, polyethylene regrind, or polypropylene.

43. The method according to claim 42, wherein the polyolefin polymer comprises the polyethylene and wherein the density ranges from about 0.920 g/cc to about 0.970 g/cc.

44. The method according to claim 43, wherein the polyolefin polymer comprises the polyethylene and wherein the density ranges from about 0.930 g/cc to about 0.970 g/cc.

45. The method according to claim 44, wherein the polyolefin polymer comprises the polyethylene and wherein the density ranges from about 0.940 g/cc to about 0.970 g/cc.

46. The method according to claim 45, wherein the polyolefin polymer comprises the polyethylene and wherein the density ranges from about 0.950 g/cc to about 0.960 g/cc.

47. The method according to claim 27, wherein the second layer comprises less than about 30 wt % of the flame retardant material.

48. The method according to claim 47, wherein the second layer comprises less than about 20 wt % of the flame retardant material.

49. The method according to claim 48, wherein the second layer comprises less than about 10 wt % of the flame retardant material.

50. The method according to claim 49, wherein the second layer comprises less than about 1 wt % of the flame retardant material.

51. The method according to claim 27, wherein the flame retardant material comprises at least one of a halogenated organic compound, antimony trioxide, alumina trihydrate, or a nitrogenous organic compound.

52. The method according to claim 51, wherein the halogenated organic compound comprises at least one of polybrominated biphenyl oxides, halogenated phosphate esters, tetrabromobisphenol A, or mixtures thereof.

53. The method according to claim 51, wherein the nitrogenous organic compound comprises at least one of urea, melamine, or formaldehyde condensates thereof.

54. The method according to claim 27, wherein the pallet assembly comprises a pallet, a dunnage tray, a tote bin, a drum, a bottle, or a building panel.
